(19) United States
(12) Patent Application Publication
(10) Pub. No.: US 2019/0164281 A1
(43) Pub. Date: May 30, 2019

(54) ROBOTIC PILL FILLING, COUNTING, AND VALIDATION

(71) Applicant: Walmart Apollo, LLC, Bentonville, AR (US)

(72) Inventors: Steven Jackson Lewis, Bentonville, AR (US); Brandon Worth, Bentonville, AR (US); William Hogg, Rogers, AR (US)

(21) Appl. No.: 16/200,844

(22) Filed: Nov. 27, 2018

Related U.S. Application Data
(60) Provisional application No. 62/590,646, filed on Nov. 27, 2017.

(51) Int. Cl. G06T 7/00; G06K 9/36; G06K 9/00; G06T 11/60; B65D 90/48

(52) U.S. Cl. CPC G06T 7/0012; G06K 9/36; G06K 9/00624; H04N 5/2256; B65D 90/48; G06T 2207/30242; G06T 11/60

(57) ABSTRACT

Exemplary embodiments of the present disclosure can analyze image(s) of pill son a tray captured by an imaging device to count the quantity of pills dispensed on the tray; generate visual proof of inventory fills for controlled substance reporting; validate correctness of items, by color, size, shape, inscription; and/or detect foreign objects, such as broken pills, incorrect pills, and/or other objects on tray. The image(s) can be augmented based on the analysis of the image(s) and augmented image(s) can be rendered on a display.

### RELATED APPLICATIONS

This application claims priority to U.S. Provisional Application No. 62/590,646 filed on Nov. 27, 2017, the content of which is hereby incorporated by reference in its entirety.

### BACKGROUND

Automated dispensing and counting of pills have been used to improve accuracy and efficiency of the prescription fulfillment process. Typically these fulfillment robots include lasers or light beams at the output of a dispenser to count the number of pills being dispensed. For example, when the light beam is interrupted, a sensor disposed opposite of the light source can detect the interruption and increment a count. However, such conventional systems dispensing systems have a limited scope and applicability.

### BRIEF DESCRIPTION OF THE DRAWINGS

FIG. 1 depicts a prescription fulfillment system in accordance with exemplary embodiments of the present disclosure.

FIG. 2 illustrates a virtual reality headset for presenting images captured by the imaging device in accordance with exemplary embodiments of the present disclosure.

FIG. 3 depicts a schematic diagram illustrating an arrangement of components of an embodiment of the prescription fulfillment system in accordance with embodiments of the present disclosure.

FIGS. 4A-C depict augmented images that can be rendered on a display in accordance with exemplary embodiments of the present disclosure.

FIG. 5 graphically depicts a process of identifying, validating, and counting pills in images captured by imaging device based on execution of the engine by the computing system.

FIG. 6 is a flowchart illustrating an example process for identifying and counting pills based on images captured of the pills being dispensed on to a tray.

FIG. 7 is a flowchart illustrating an example process for identifying, validating, and counting pills based on images captured of the pills being dispensed on to a tray.

### DETAILED DESCRIPTION

Exemplary embodiments of the present disclosure can analyze image(s) of pill son a tray captured by an imaging device to count the quantity of pills dispensed on the tray; generate visual proof of inventory fills for controlled substance reporting; validate correctness of items, by color, size, shape, inscription; and/or detect foreign objects, such as broken pills, incorrect pills, and/or other objects on tray. The image(s) of the pills can be augmented based on the analysis of the image(s) and the augmented image(s) can be rendered on a display.

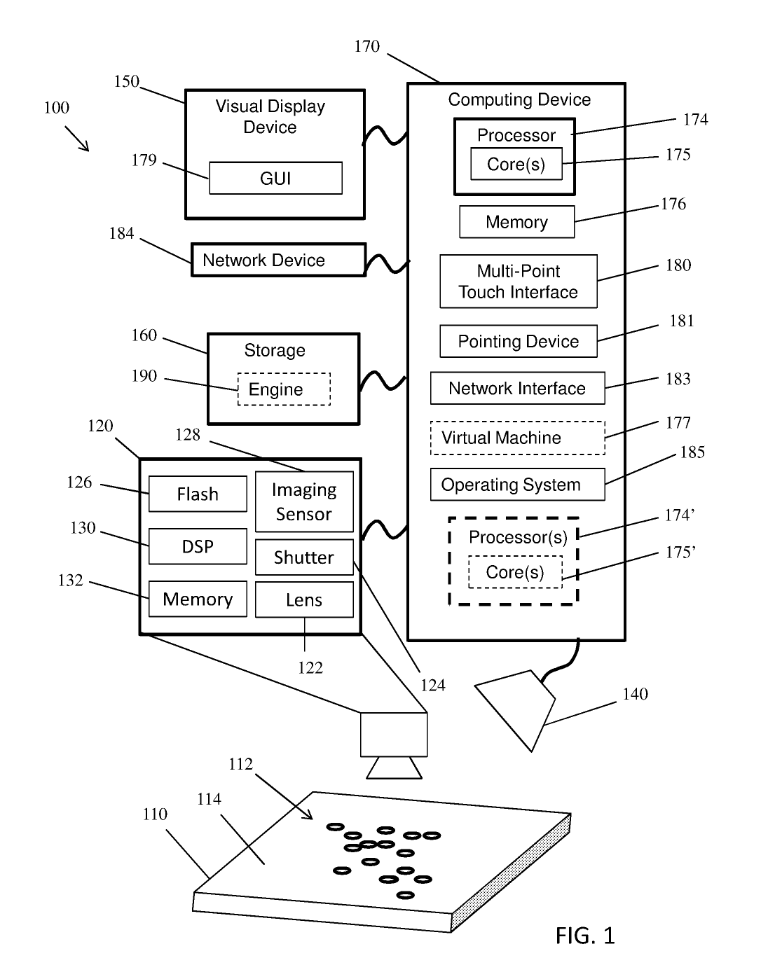

FIG. 1 depicts a prescription fulfillment system 100 in accordance with exemplary embodiments of the present disclosure. The system 100 can include a tray 110, an imaging device 120, a light source 140, a display 150, storage 160, and a computing device 170. The system can be configured to detect, count, and validate pills 112 received by the tray based on one or more images captured by the imaging device 120. The image can form an input to the computing device 170 that implements an analysis engine 190.

The tray 110 can have a generally planar surface 114 for supporting the pills 112 to be imaged by the imaging device 120. The planar surface can have a matte finish or a gloss finish and can be formed from plastic, metal, ceramics, and/or carbon composites. The planar surface can be one or more colors, such as black, white, red, green, yellow, blue, pink, and/or gray. The tray 110 can be opaque, translucent, or transparent.

The imaging device 120 can be a digital still camera or digital video camera, that includes a lens 122, a shutter 124, a flash 126, an imaging sensor 128 (e.g., a CMOS imaging sensor or a charged coupled device (CCD) imaging sensor), a digital signal processor (DSP) 130, and memory 132, as well as, other components commonly included in digital cameras including, for example, timing generators, amplifiers, digital-to-analog converters, and the like. The imaging sensor 128 can include pixels having sensitivities to red, green, and blue components. The imagining device can capture images of embodiments of the tray 110 with one or more pills disposed thereon. For example, an image of tray 110 and pills can be formed as charges on pixels of the imaging sensor 128 by receiving light through the lens 122 when the shutter 124 is open. The charge on the pixels can be output by the sensor to the DSP 130 via one or more amplifier/gain stages, which can process the charge from the imaging sensor 128 to form the image captured by the imaging sensor 128 and store the image in the memory 132. In some embodiments, the DSP 130 can be programmed to implement embodiments of the analysis engine 190, which can be stored in the memory 132, and/or the imaging device 120 can include another processing device (e.g., a microcontroller) that interfaces with the memory 132 and is programmed to implement the analysis engine 190.

The one or more light sources 140 can be a light emitting diode, an array of light emitting diodes, an incandescent light, a fluorescent light, a halogen light, and/or any suitable light. In some embodiments, the light source 140 can be the camera flash 126 attached to or integrally formed with the imaging device 120. The light source 140 emits light having a specified intensity, color temperature, wavelength, power spectral density, etc. The light source 140 can emit light in the visible and/or infrared spectrums, and can output one or more colors of light concurrently and/or as a function of time. In some embodiments, the light source 140 can be controlled by the computing device 170 to illuminate the tray with light having specified parameters (e.g., intensity, color temperature, wavelength, power spectral density, etc.). One or more filters and/or diffusers can be disposed between the light source and the tray to modify the light after it is emitted from the light source and before it impinges upon the tray. The tray 110 can be opaque, translucent, or transparent.

The display 150 can be communicatively coupled to the computing device 170 and can configured to render one or more graphical user interfaces generated by the computing device 170 (e.g., in response to execution of the analysis engine), to render one or more images captured by the imaging device 120, and/or to render one or more images captured by the imaging device 120 as augmented by the computing device 170. The display 150 can be, for example, a cathode ray tube display, an LED or organic LED display, and/or a plasma display. In exemplary embodiments, the display 150 can be embodiments as a virtual reality headset as described herein.

The storage 160 can be embodied as one or more non-transitory computer-readable media. Exemplary types of storage 160 can include, but are not limited to, one or more types of hardware memory, non-transitory tangible media (for example, one or more magnetic storage disks, one or more optical disks, one or more flash drives), and the like. In exemplary embodiments, the storage 160 stores one or more computer-executable instructions or software for implementing exemplary embodiments of an analysis engine 190 on the computing device 170. The storage 160 can also store information about pills (e.g., color, shape, size, inscriptions, mass) that may be placed on the tray, images captured by the imaging device 120, augmented images generated by the computing device 170, pill quantities detected in the images and/or augmented images, pill types detected in the images and/or augmented images, pill colors detected in the images and/or augmented images, pill shapes detected in the images and/or augmented images, pill sizes in the images and/or augmented images, pill locations (pixel coordinates) detected in the images and/or augmented images, pill outlines (e.g., based on pixel coordinates) detected in the images and/or augmented images, foreign objects detected in the images and/or augmented images, and any other suitable information for implementing embodiments of the present disclosure.

The computing device 170 can be configured to be in communication with the imaging device 120 to receive the image captured by the imaging device, and to process the image with the analysis engine 190. The analysis engine 190 can be implemented (e.g., by the imaging device 120 and/or the computing device 190) to determine, e.g., a quantity, size, shape, color, and the like of the pills disposed on the tray 110. Memory 176 included in the computing device 170 may store computer-readable and computer-executable instructions or software for implementing exemplary embodiments and/or may cache information generated and/or utilized by the computing device 170 to implement embodiments of the present disclosure. The computing device 170 also includes processor 174 and associated core 175, and optionally, one or more additional processor(s) 174′ and associated core(s) 175′ (for example, in the case of computer systems having multiple processors/cores), for executing computer-readable and computer-executable instructions or software stored in the memory 176 and other programs for controlling system hardware. Processor 174 and processor(s) 175′ may each be a single core processor or multiple core (175 and 175′) processor.

Virtualization may be employed in the computing device 170 so that infrastructure and resources in the computing device may be shared dynamically. A virtual machine 177 may be provided to handle a process running on multiple processors so that the process appears to be using only one computing resource rather than multiple computing resources. Multiple virtual machines may also be used with one processor.

Memory 176 may include a computer system memory or random access memory, such as DRAM, SRAM, EDO RAM, and the like. Memory 176 may include other types of memory as well, or combinations thereof.

A user may interact with the computing device 170 through the display device 150, which may display one or more user interfaces 179 that may be provided in accordance with exemplary embodiments. The computing device 170 may include other I/O devices for receiving input from a user, for example, a keyboard or any suitable multi-point touch interface 180, a pointing device 181 (e.g., a mouse). The keyboard 180 and the pointing device 181 may be coupled to the visual display device 150. The computing device 180 may include other suitable conventional I/O peripherals.

The computing device 170 can include a network interface 183 configured to interface via one or more network devices 184 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 183 may include a built-in network adapter, network interface card, PCMCIA network card, card bus network adapter, wireless network adapter, USB network adapter, modem or any other device suitable for interfacing the computing device 170 to any type of network capable of communication and performing the operations described herein. Moreover, the computing device 170 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 170 may run any operating system 185, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 185 may be run in native mode or emulated mode. In an exemplary embodiment, the operating system 185 may be run on one or more cloud machine instances. In some embodiments, the computing device 170 can be communicatively coupled to the imaging device 120.

In exemplary embodiments, the engine 190 can be executed by the computing device 170 to capture and receive one or more images from the imaging device 120 and/or can retrieve the one or more images from memory (e.g., non-transitory computer-readable media) after the imaging device 120 captures the images. The computing device 170 can execute the engine 190 to count a quantity of pills dispensed on a tray; generate visual proof of inventory fills for controlled substance reporting; validate correctness of items, by color, size, shape, inscription; and/or detect foreign objects, such as broken pills, incorrect pills, and/or other objects on tray.

Based on the image analysis, the computing device 170 can render information about the analysis and/or augment the images on the display 150. The computing device 170 can execute the engine 190 to augment the images captured by the imaging device 120 by overlaying information associated with the pills captured in the image rendered on the display 150. The computing device 170 can overlay an outline of a shape of the pills and/or can overlay an indicator or color on the detected pills based on one or more attributes of the pills. The computing device 170 can display the information associated with the pills inside the outline of the shape of the pills and/or can overlay information image so that is it does not obstructed a view of the pills.

In some embodiments, the computing device 170 can generate a split screen, where one side of the split screen shows an image captured by the imaging device 120 and the other side of the split screen shows information about the pills in the image. The information overlaid or superimposed on the augmented image(s) can include a determined name of a drug embodied by the pills, a determined type of the pills, a determined size of the pills, a determined shape of the pills, a determined color of the pills, determined inscriptions on the pills, a determined quantity of the pills in the image, a quantity of pills required to fill a prescription, determined foreign objects, and the like.

Execution of the engine 190 can cause the computing device 170 to discriminate between individual pills in the one or more captured images. For example, exemplary embodiments can identify individual pills by detecting the border or boundary of the individual pills based on changes in attributes of the pixels at the boundaries of the individual pills. For example, changes in hue, lightness, brightness, chroma, colorfulness, and saturation of neighboring pixels can be detect and a pattern of these changes can be used to isolate individual pills in the one or more images. Tri-stimulus values (i.e., X, Y, and Z tri-stimulus values can be used to determine and attempt to match pill colors captured in the image(s) to expected pill color for a particular pill being dispensed.

The computer device 170 can execute the engine 190 to perform one or more processes and/or algorithms for facilitating discrimination of objects in the images captured by the imaging device 120. For example, blurring, normalized lighting, greyscaling, OTSU, thresholding, erosion/dilation, convert correct hull, defects contour detection, edge detection, and/or blob/mass calculation normalization can be used to identify, count, and validate pills on the tray based on the image(s) captured by the imagining device.

As one example, the computing device 170 utilize color inversion to inverter the colors in the images captured by the imaging device. After the color of an image is inverted, the computing device can execute the engine 190 to facilitate shape detection based on pixel parameters, clustering, and/or pixel patterns. After individual shapes are identified in the images, the pattern recognition and resolution modification can be utilized to determine information associated with the individual shapes (e.g., whether the individual shapes correspond to a particular pill, a foreign object, and/or the tray).

As one non-limiting example, the computing device 170 can execute the engine 190 to identify one or more pixels in a cluster having an expected set of attributes that correspond to the attributes of the tray 110 when imaged by the imaging device 120. Once one or more pixels of the image have been classified as being part of the tray, the computing device can execute the engine to identify all pixels that correspond to the tray 110. The pixels that do not correspond to the expected attributes of the tray are processed to determine a number of clusters of these pixels.

Each cluster of pixels can be processed to determine dimensions associated with the cluster (e.g., a quantity of pixels long and wide, an area of the cluster). Based on the size of the cluster and the attributes of the pixels in the cluster, the computing device 170 can determine whether the cluster of pixels represents a pill in the image. In exemplary embodiments, the computing device 170 can receive as an input a description of the pills expected to be disposed on the pill and can determine whether the size and shape of the cluster of pixels corresponds to the size and shape of the pills expected to be disposed on the tray, and can determine whether the attributes of the pixels in the cluster correspond to the attributes of the pills expected to be disposed on the tray. If so, the computing device 170 can execute the engine to classify the cluster as a pill and can increment a counter. The computing device can repeat this process for each cluster of pixels identified by the computing device 170 and can increment the counter each time a cluster of pixels is identified as being a pill.

As another non-limiting example, the computing device 170 can execute the engine to identify one or more pixels in a cluster having an expected set of attributes that correspond to the attributes of the pills expected to be disposed on the tray when imaged by the imaging device 120. Once one or more pixels of the image have been classified as being associated with the pills, the computing device can execute the engine to identify all pixels that correspond to the pills. The pixels that correspond to the expected attributes of the pills are processed to determine a number of clusters of these pixels.

Each cluster of pixels can be processed to determine dimensions associated with the cluster (e.g., a quantity of pixels long and wide, an area of the cluster). Based on the size of the cluster and the attributes of the pixels in the cluster, the computing device 170 can determine whether the cluster of pixels represents a pill in the image. In exemplary embodiments, the computing device 170 can receive as an input a description of the pills expected to be disposed on the pill and can determine whether the size and shape of the cluster of pixels corresponds to the size and shape of the pills expected to be disposed on the tray, and can determine whether the attributes of the pixels in the cluster correspond to the attributes of the pills expected to be disposed on the tray. If so, the computing device 170 can execute the engine to classify the cluster as a pill and can increment a counter. The computing device can repeat this process for each cluster of pixels identified by the computing device 170 and can increment the counter each time a cluster of pixels is identified as being a pill.

The coordinates and parameters of the pixels corresponding to the individual pills in the images can be stored and subsequently used by the computing device 170 executing the engine 190 to augment the images. Pixels that are determined as not corresponding to the pills or the tray can be classified as foreign objects by the computing device 170, and the coordinates and pixel parameters of the foreign objects can be stored and subsequently used by the computing device 170 executing the engine 190 to augment the images.

In some embodiments, the imaging device 120 can capture a series or stream of images (e.g., video), and the computing device 170 can count and validate the pills being dispensed as the pills are being dispensed. As one example, the imaging device can stream video to the computing device 170, which can detect when a pill is dispensed and can increment the counter based on detection of the pill being dispensed and can validate the pill that was dispensed. As more pills are being dispensed, the computing device 170 tags and keeps track of the pills that were previously dispensed and accounted for and determines whether additional pills have be dispensed on the tray. When it detects the additional pills, the computing device 170 tags and tracks the additional pills.

In some embodiments, the computing device 170 executing the engine can facilitate prioritized/enhanced filling of prescriptions. The image analysis performed by the computing device 170 can alter the order in which prescriptions are filled based on the items being filled at a given time. For example, if there is another fill of the same item in the queue, the computing device 170 can analyze fulfillment priority and timing to determine whether to modify the fulfillment order and the prescriptions out-of-order so that the next order to be filled is changed to be another prescription for the same item that is currently being filled (e.g., while the item is already set up to be dispensed. In some embodiments, instead of automatically changing the fulfillment order, the computing device 170 can recommend, for example, that three vials of 30 pills be filled order of the based on the image analysis, since the bottle is already open and three of these types of prescriptions are filled per day, and historic fulfillment (e.g., upon determining that most maintenance fills have the same quantity they can be pre-filled).

When it is determined that changes to a pills color, shape, size (on purpose), the computing device 170 can be configured to automatically print or suggest a warning label change to inform a patient that the color/shape/size of the pills have changed.

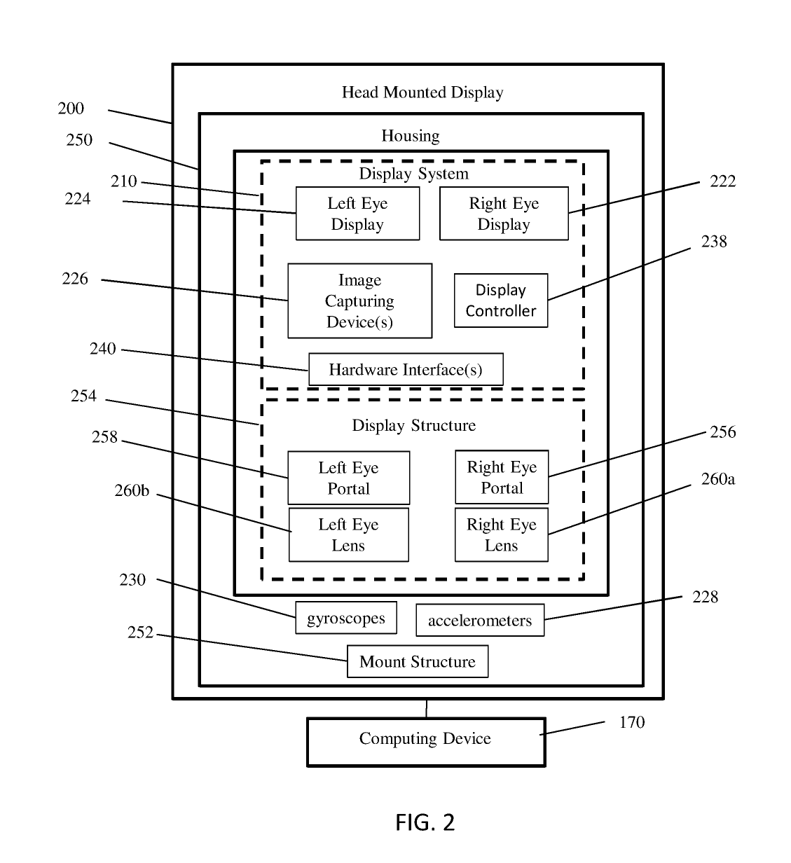

FIG. 2 illustrates a virtual reality headset 200 for presenting information and/or images captured by the imaging device in virtual 3D environment and augmenting the images according to an exemplary embodiment. The virtual reality headset 200 can be a head mounted display (HMD). The virtual reality headset 200 and the computing system 170 can be communicatively coupled to each other via wireless or wired communications.

The virtual reality headset 200 can include circuitry disposed within a housing 250. The circuitry can include a display system 210 having a right eye display 222, a left eye display 224, and one or more image capturing devices 226, one or more display controllers 238 and one or more hardware interfaces 240.

The right and left eye displays 222 and 224 can be disposed within the housing 250 such that the right display is positioned in front of the right eye of the user when the housing 250 is mounted on the user's head and the left eye display 224 is positioned in front of the left eye of the user when the housing 250 is mounted on the user's head. In this configuration, the right eye display 222 and the left eye display 224 can be controlled by one or more display controllers 238 to render images on the right and left eye displays 222 and 224 to induce a stereoscopic effect, which can be used to generate three-dimensional images. In exemplary embodiments, the right eye display 222 and/or the left eye display 224 can be implemented as a light emitting diode display, an organic light emitting diode (OLED) display (e.g., passive-matrix (PMOLED) display, active-matrix (AMOLED) display), and/or any suitable display.

In some embodiments the display system 210 can include a single display device to be viewed by both the right and left eyes. In some embodiments, pixels of the single display device can be segment by the one or more display controllers 238 to form a right eye display segment and a left eye display segment within the single display device, where different images of the same scene can be displayed in the right and left eye display segments. In this configuration, the right eye display segment and the left eye display segment can be controlled by the one or more display controllers 238 disposed in a display to render images on the right and left eye display segments to induce a stereoscopic effect, which can be used to generate three-dimensional images.

The one or more display controllers 238 can be operatively coupled to right and left eye displays 222 and 224 (or the right and left eye display segments) to control an operation of the right and left eye displays 222 and 224 (or the right and left eye display segments) in response to input received from the computing system 170. In exemplary embodiments, the one or more display controllers 238 can be configured to render images on the right and left eye displays (or the right and left eye display segments) of the same scene and/or objects, where images of the scene and/or objects are render at slightly different angles or points-of-view to facilitate the stereoscopic effect. In exemplary embodiments, the one or more display controllers 238 can include graphical processing units.

The one or more hardware interfaces 240 can facilitate communication between the virtual reality headset 200 and the computing system 170. The virtual reality headset 200 can be configured to transmit data to the computing system 170 and to receive data from the computing system 400 via the one or more hardware interfaces 240. As one example, the one or more hardware interfaces 240 can be configured to receive data from the computing system 170 corresponding to images and augmented images and can be configured to transmit the data to the one or more display controllers 238, which can render the images on the right and left eye displays 222 and 224 to render augmented images.

The housing 250 can include a mounting structure 252 and a display structure 254. The mounting structure 252 allows a user to wear the virtual reality headset 200 on his/her head and to position the display structure over his/her eyes to facilitate viewing of the right and left eye displays 222 and 224 (or the right and left eye display segments) by the right and left eyes of the user, respectively. The mounting structure can be configured to generally mount the virtual reality headset 200 on a user's head in a secure and stable manner. As such, the virtual reality headset 200 generally remains fixed with respect to the user's head such that when the user moves his/her head left, right, up, and down, the virtual reality headset 200 generally moves with the user's head.

The display structure 254 can be contoured to fit snug against a user's face to cover the user's eyes and to generally prevent light from the environment surrounding the user from reaching the user's eyes. The display structure 254 can include a right eye portal 256 and a left eye portal 258 formed therein. A right eye lens 260a can be disposed over the right eye portal and a left eye lens 260b can be disposed over the left eye portal. The right eye display 222, the one or more capturing devices 226 behind the lens 260a of the display structure 254 covering the right eye portal 256 such that the lens 256 is disposed between the user's right eye and each of the right eye display 222 and the one or more right eye image capturing devices 226. The left eye display 224 and the one or more image capturing devices 228 can be disposed behind the lens 260b of the display structure covering the left eye portal 258 such that the lens 260b is disposed between the user's left eye and each of the left eye display 224 and the one or more left eye image capturing devices 228.

The mounting structure 252 can include a left band 251 and right band 253. The left and right band 251, 253 can be wrapped around a user's head so that the right and left lens are disposed over the right and left eyes of the user, respectively.

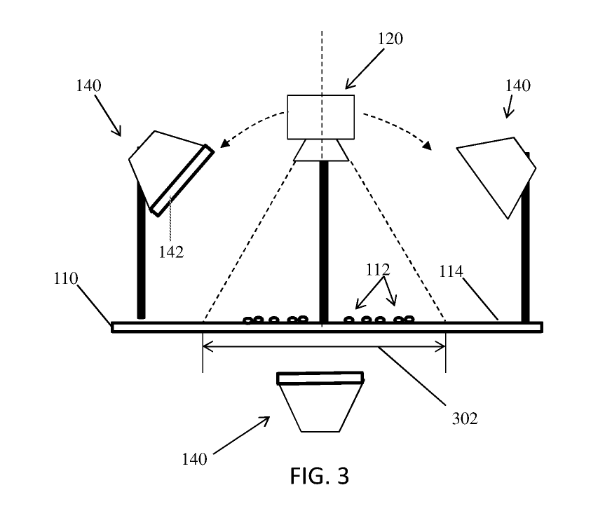

FIG. 3 depicts a schematic diagram illustrating an arrangement of components of an embodiment of the prescription fulfillment system in accordance with embodiments of the present disclosure. As shown in FIG. 3, the system 100 can include one or more of the light sources 140 disposed in different positions and orientations relative to the imaging device 120 and/or the planer surface 114 of the tray 110. As one example, the light source 140 can be disposed in a first position and orientation A, a second position and orientation B, and/or a third position and orientation C. As another example, multiple light sources can be used and an instance of the light source 140 can be disposed at the first position and orientation A, the second position and orientation B, and/or the third position and orientation C. The light source 140 can be configured to emit coherent and/or incoherent light. In some embodiments, one or more of the light sources can include a filter/diffuser 142 to alter the light emitted from the light source 140. In an non-limiting example, the light source can emit light that is incident on the planar surface at an angle (such as the specular angle) and the imaging device can be positioned above the planar surface 114 to image the planar surface 140 along an axis that is normal (90 degrees) relative to the planar surface 140. In another non-limiting example, the light source 140 can be disposed to emit light in a downward direction towards the planar surface 114 or can be disposed under the tray to emit light upwards through the tray 110 (e.g., when the tray 110 is translucent or transparent).

The imaging device 120 can have a field-of-view 302 such that images captured by the imaging device correspond to the field-of-view 302. The position and orientation of the imaging device can be specified to so that the imaging device 120 images the planar surface 114 at an angle other than normal to the planar surface (e.g., 10, 15, 25, 35, 45, 55, 65, 75, 85, 95, 105, 115, 125, 135, 145, 155, 165, 175 degrees). In some embodiments, the imaging device 120 can be configured to change position and/or orientation between image captures or between sequences of image captures.

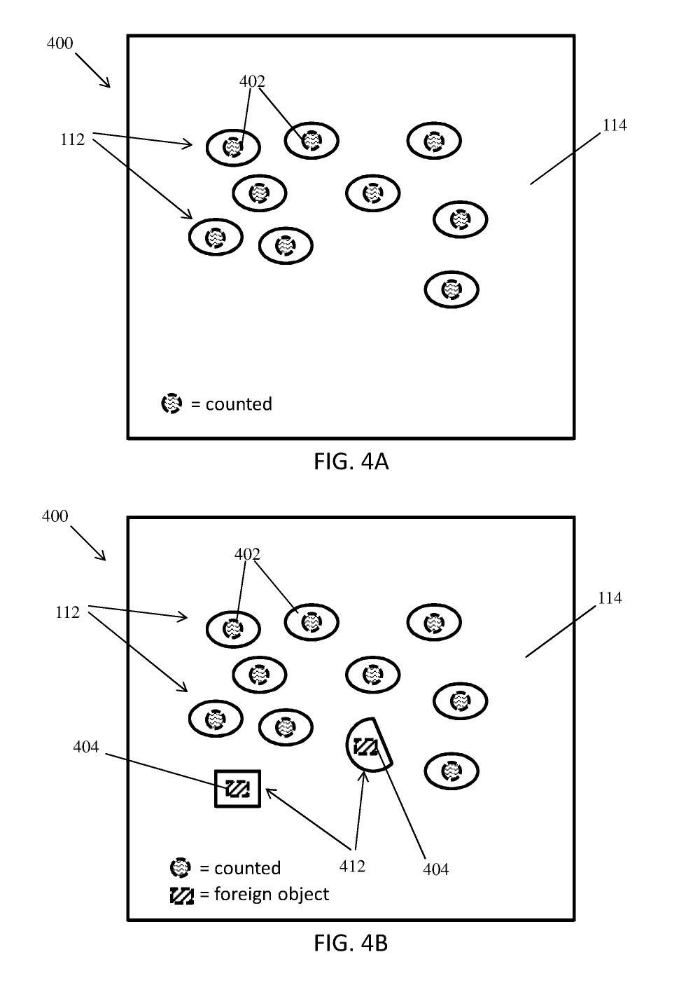

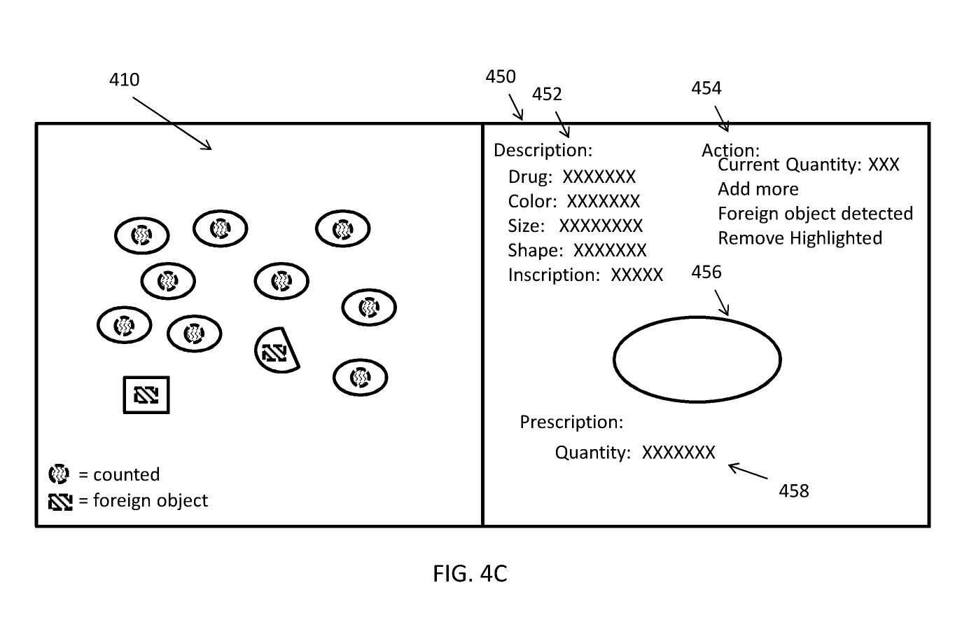

FIGS. 4A-C depict exemplary augmented images that can be rendered on a display of the system in accordance with embodiments of the present disclosure. FIG. 4A shows an augmented image 400 rendered on the display of an image captured by the imaging device that has been processed by the engine executed by the computing device 170. The image 400 includes the planar surface 114, the pills 112, and visual indicators 402 superimposed on the pills 112. In the present example, the visual indicators 402 indicate the computing device 170 has detected, validated, and counted the pills 112.

FIG. 4B shows an augmented image 410 rendered on the display of an image captured by the imaging device that has been processed by the engine executed by the computing device 170. The image 410 includes the planar surface 114, the pills 112, foreign objects 412, visual indicators 402 superimposed on the pills 112, and visual indicators 404 superimposed on the foreign objects. In the present example, the visual indicators 402 indicate the computing device 170 has detected, validated, and counted the pills 112, and the visual indicators 404 indicate that the computing device has determined that the detected objects associated with the visual indicators 404 do not correspond to the pills 112 and/or the pills expected to be dispensed on the planar surface 114.

FIG. 4C shows a split screen that includes the augmented image 410 rendered on the left side of the display and analysis information 450 on the right side of the display. The analysis information can include information 452 about the pills expected to be dispensed on the tray, the quantity of the pills 454 detected by the computing device as well as what action are required and whether foreign objects have been detected. The information can also include an image 456 of what the pills to be dispensed on the tray look like and prescription information 458, such as the quantity of pills required to fulfill the prescription.

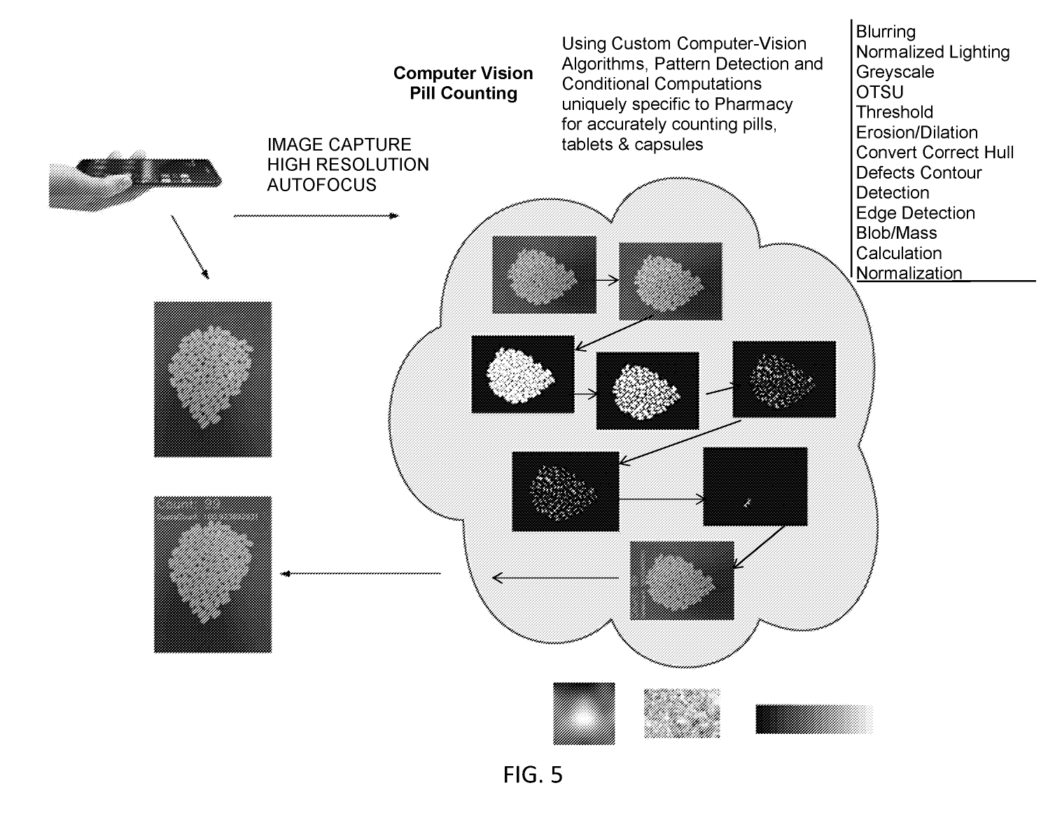

FIG. 5 graphically depicts a process of identifying, validating, and counting pills in images captured by imaging device based on execution of the engine by the computing system. An image of pills is captured by the imaging device and the image 502 is processed using a sequence of blurring, normalized lighting, greyscaling, OTSU, thresholding, erosion/dilation, convert correct hull, defects contour detection, edge detection, and blob/mass calculation normalization, respectively, as denoted by arrows between images in the sequence on the right side of FIG. 5.

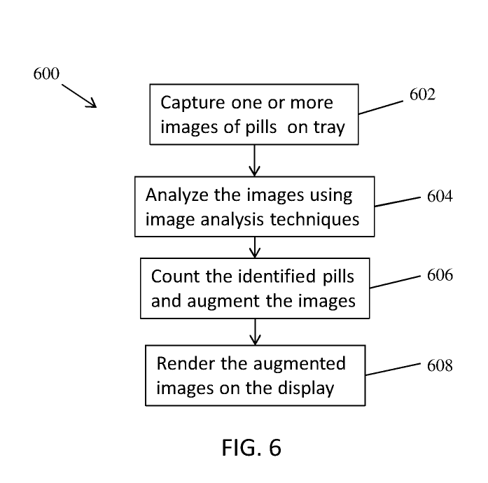

FIG. 6 is a flowchart illustrating an exemplary process 600 for identifying and counting individual pills in accordance with embodiments of the present disclosure. At step 602, images of pills being dispensed on a tray are captured by the imaging device. At step 604, the images are received by the computing device and the computing device analyzes the images using a sequence of image analysis techniques to identify individual pills in the images. For example, the computing device can detect individual pills uses a sequence of one or more of the following image analysis techniques: blurring, normalized lighting, greyscaling, OTSU, thresholding, erosion/dilation, convert correct hull, defects contour detection, edge detection, and/or blob/mass calculation normalization. At step 606, after the individual pills are identified in the image, the computing device counts the pills to determine a quantity of pills in the image and augments the images. For example, the computing device can superimpose visual indicators on each of the individual counted pills. At step 608, the augmented images are rendered on the display by the computing device.

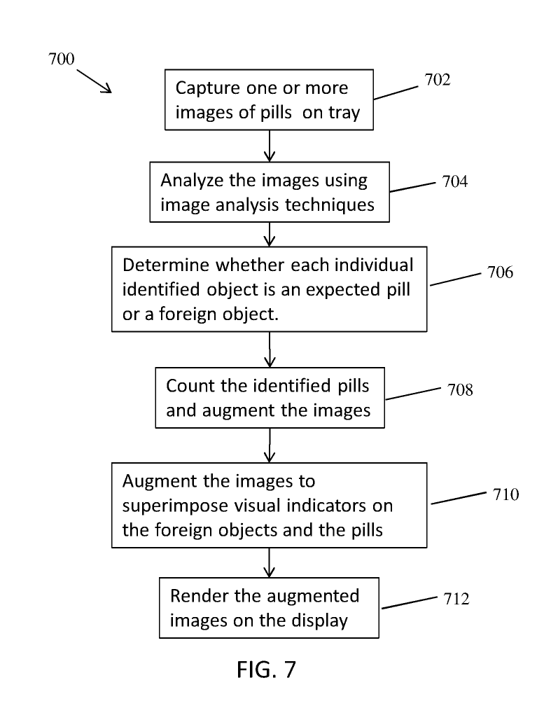

FIG. 7 is a flowchart illustrating an exemplary process 700 for identifying, counting, and validating individual pills in accordance with embodiments of the present disclosure. At step 702, images of pills being dispensed on a tray are captured by the imaging device. At step 704, the images are received by the computing device and the computing device analyzes the images using a sequence of image analysis techniques to identify individual objects in the images, as described herein. At step 706, after the individual objects are identified in the image, the computing device compares pixel parameters of each individual object to pixel parameters of pills expected to be dispensed on to the tray. Objects that have pixel parameters that do not match (outside of a specified tolerance) the expected pixel parameters are identified as foreign objects and objects that do match (within a specified tolerance) the expected pixel parameters are identified as the pills. At step 708, the computing device counts the identified pills to determine a quantity of pills in the image. At step 710, the computing device augments the images. For example, the computing device can superimpose visual indicators on each of the individual counted pills and can superimpose different visual indicators on the foreign objects. At step 712, the augmented images are rendered on the display by the computing device.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

1. A method of analyzing an image to identify and count pills being dispensed on a tray, the method comprising:
receiving, by a computing device, an image including a surface of a tray and objects on the tray;
executing, by the computing device, a sequence of image analysis techniques to identify individual objects in the image; and
counting, by the computing device, each of the individual objects that are identified to determine a quantity of objects on the tray.

2. The method of claim 1, further comprising:
augmenting the image based on individual objects identified.

3. The method of claim 2, wherein augmenting the image comprises:
superimposing, in the image, a visual indicator on each individual object identified in the image.

4. The method of claim 1, wherein the image analysis techniques include at least one of blurring, normalized lighting, greyscaling, OTSU, thresholding, erosion/dilation, convert correct hull, defects contour detection, edge detection, or blob/mass calculation normalization.

5. The method of claim 1, wherein the sequence in which the image analysis techniques executed comprises blurring, normalized lighting, greyscaling, OTSU, thresholding, erosion/dilation, convert correct hull, defects contour detection, edge detection, and blob/mass calculation normalization.

6. The method of claim 1, wherein a stream of images are received by the computing device as the objects are being dispensed on the tray.

7. The method of claim 1, further comprising:
determining, for each identified object, whether each of the identified objects corresponds to a foreign object or to a pill expected to be dispensed on the tray.

8. The method of claim 7, wherein counting each of the individual objects comprises:
counting each of the identified objects that correspond to a pill expected to be dispensed on the tray.

9. The method of claim 7, wherein augmenting the image comprises:
superimposing, in the image, a first visual indicator on each of the objects identified as corresponding to an expected pill; and
superimposing, in the image, a second visual indicator on each of the objects identified as corresponding to a foreign object.

10. A system of analyzing an image to identify and count pills being dispensed on a tray, the system comprising:
a tray;
one or more light sources illuminating the tray;
one or more imaging devices configured to capture images of a surface of the tray upon which objects are dispensed;
a computing device configured to receive the images from the one or more imaging device, the computing device configured to:
execute, by the computing device, a sequence of image analysis techniques to identify individual objects in the image; and
count, by the computing device, each of the individual objects that are identified to determine a quantity of objects on the tray.

11. The system of claim 10, wherein the computing device is configured to:
augment the image based on individual objects identified.

12. The system of claim 11, wherein the computing device is configured to augment the image by superimposing, in the image, a visual indicator on each individual object identified in the image.

13. The system of claim 10, wherein the image analysis techniques include at least one of blurring, normalized lighting, greyscaling, OTSU, thresholding, erosion/dilation, convert correct hull, defects contour detection, edge detection, or blob/mass calculation normalization.

14. The system of claim 10, wherein the sequence in which the image analysis techniques executed comprises blurring, normalized lighting, greyscaling, OTSU, thresholding, erosion/dilation, convert correct hull, defects contour detection, edge detection, and blob/mass calculation normalization.

15. The system of claim 10, wherein a stream of images are received by the computing device as the objects are being dispensed on the tray.

16. The system of claim 10, wherein the computing device is configured to:
determine, for each identified object, whether each of the identified objects corresponds to a foreign object or to a pill expected to be dispensed on the tray.

17. The system of claim 16, wherein the computing device is configured to count each of the individual objects by counting each of the identified objects that correspond to a pill expected to be dispensed on the tray.

18. The system of claim 16, wherein the computing device is configured to augment the image by superimposing, in the image, a first visual indicator on each of the objects identified as corresponding to an expected pill, and superimposing, in the image, a second visual indicator on each of the objects identified as corresponding to a foreign object.
